(19) United States
(12) Patent Application Publication
(10) Pub. No.: US 2003/0002276 A1
(43) Pub. Date: Jan. 2, 2003

(54) Handle having a light-emitting structure

(76) Inventor: Shou Mao Chen, Taichung Hsien (TW)

Correspondence Address: HARRISON & EGBERT, 412 Main Street, 7th Floor, Houston, TX, 77002, US

(21) Appl. No.: 09/892,354

(22) Filed: Jun. 28, 2001

(51) Int. Cl. F21V 33/00

(52) U.S. Cl. 362/109; 362/157

(57) ABSTRACT

A handle comprises a main body, a control member, and a light emitting member. The control member and the light-emitting member are disposed in a receiving space of the main body. As the control member is pressed with finger, the light-emitting member emits light. The cessation of light emission by the light-emitting member is brought about by freeing the control member from the pressure exerting thereon.

### BACKGROUND OF THE INVENTION

1. Field of the Invention

The present invention relates generally to a handle, and more particularly to a handle having a means to emit light.

2. Description of Related Art

As shown in FIG. 1, a prior art handle 10 comprises a cross bar 11 and two upright support rods 12 which are fastened to an object, such as a luggage shell. The prior art handle 10 is monotonous in design.

### BRIEF SUMMARY OF THE INVENTION

The primary objective of the present invention is to provide a handle with a means to emit light for enhancing the versatility of the handle.

In keeping with the principle of the present invention, the foregoing objective of the present invention is attained by a handle comprising a main body, a light-emitting member disposed in the interior of the main body, and a control member disposed in the main body such that the control member is in contact with the light-emitting member at such time when the control member is exerted on by an external force. The light-emitting member is capable of emitting light at the time when the control member is pressed with finger.

The features and the functions of the present invention will be more readily understood upon a thoughtful deliberation of the following detailed description of the present invention with reference to the accompanying drawings.

### BRIEF DESCIPTION OF THE SEVERAL VIEWS OF THE DRAWINGS

FIG. 1 shows a perspective view of a luggage handle of the prior art.

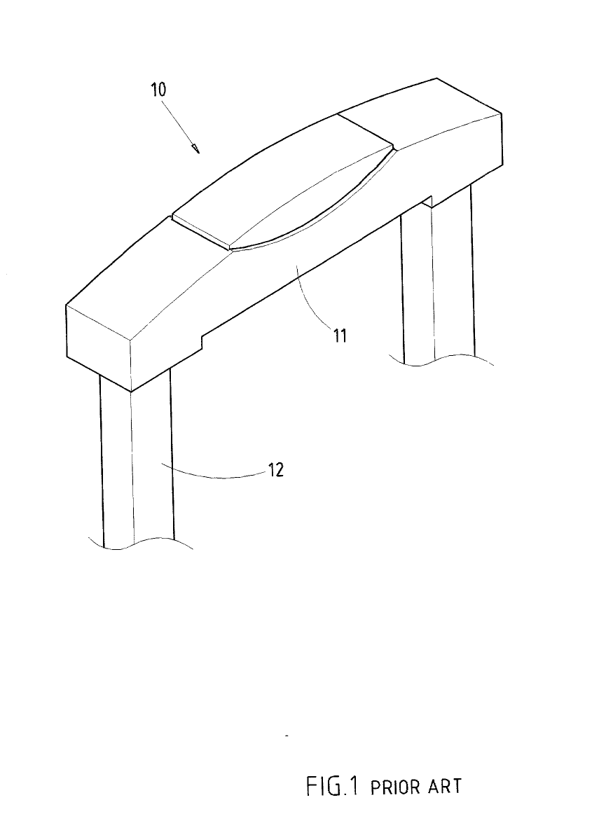

FIG. 2 shows a perspective view of a handle of the present invention.

FIG. 3 shows an exploded view of the handle of the present invention.

FIG. 4 shows a schematic view of the handle of the present invention in use.

FIG. 5 shows another schematic view of the handle of the present invention in conjunction with a luggage.

FIG. 6 shows a press flow of the control member and the light emitting member of the handle of the present invention.

### DETAILED DESCRIPTION OF THE INVENTION

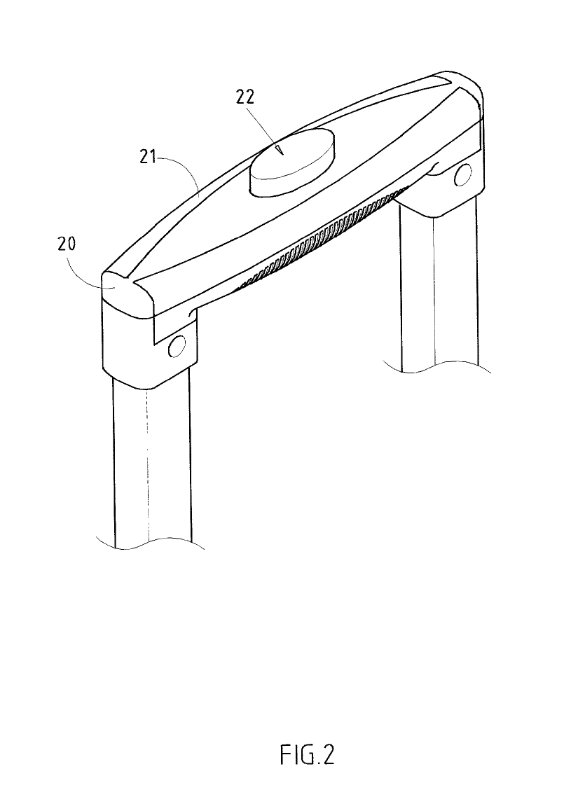

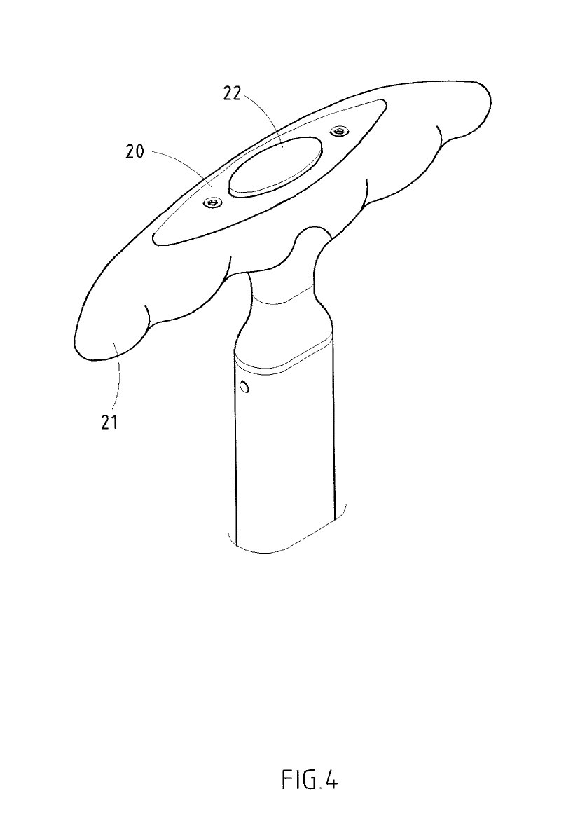

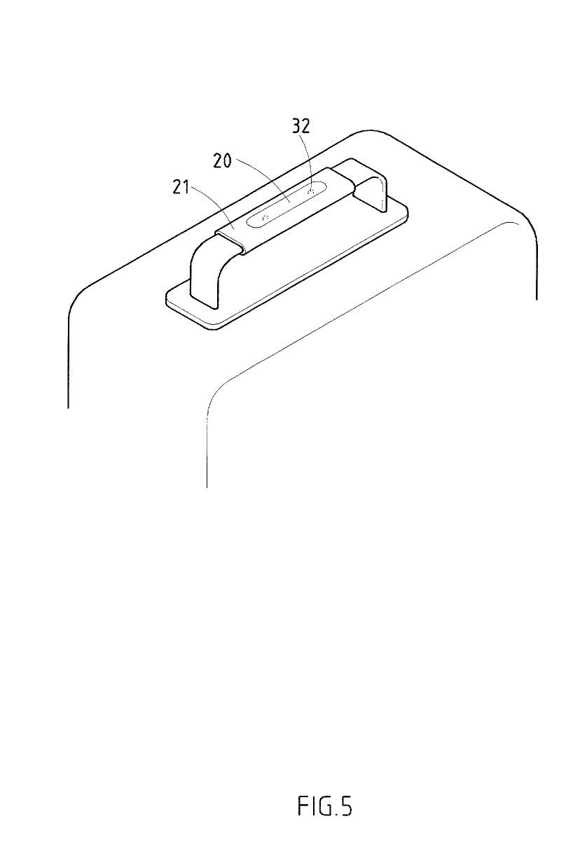

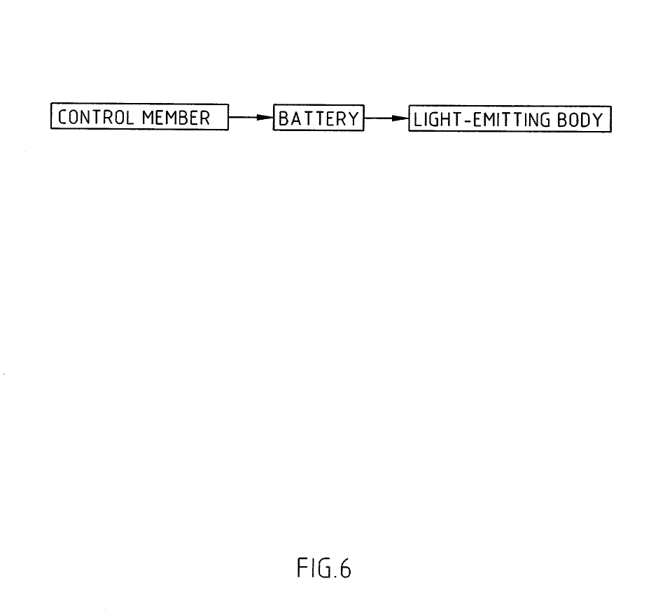

As shown in FIGS. 2-6, a handle embodied in the present invention comprises a main body 20, a control member 22, and a light-emitting member 30.

The main body 20 is of a rod-shaped construction and is made of a transparent or translucent material. The main body 20 is provided in the interior with a receiving space to accommodate the control member 22 and the light-emitting member 30.

The control member 22 is formed of a press button and a spring. The control member 22 is disposed in the receiving space of the main body 20 such that the press button is partially jutted out of the longitudinal upper surface of the main body 20.

The light-emitting member 30 is disposed in the receiving space of the main body 20 such that the light-emitting member 30 is located under the control member 22. The light-emitting member 30 is formed of a battery 31, one or more light-emitting bodies 32, and a circuit 33 in communication with the battery 31 and the light-emitting bodies 32.

Under the circumstance that the control member 22 is not exerted on by an external force, the light-emitting bodies 32 of the light-emitting member 30 are disconnected with the battery 31. As soon as the control member 22 is exerted on by the external force, the light-emitting bodies 32 are connected with the battery 31, thereby resulting in emission of light by the light-emitting bodies 32. When the control member 22 is relieved of the external force exerting thereon, the light-emitting bodies 32 become disconnected with the battery 31, thereby resulting in cessation of emission of light by the light-emitting bodies 32.

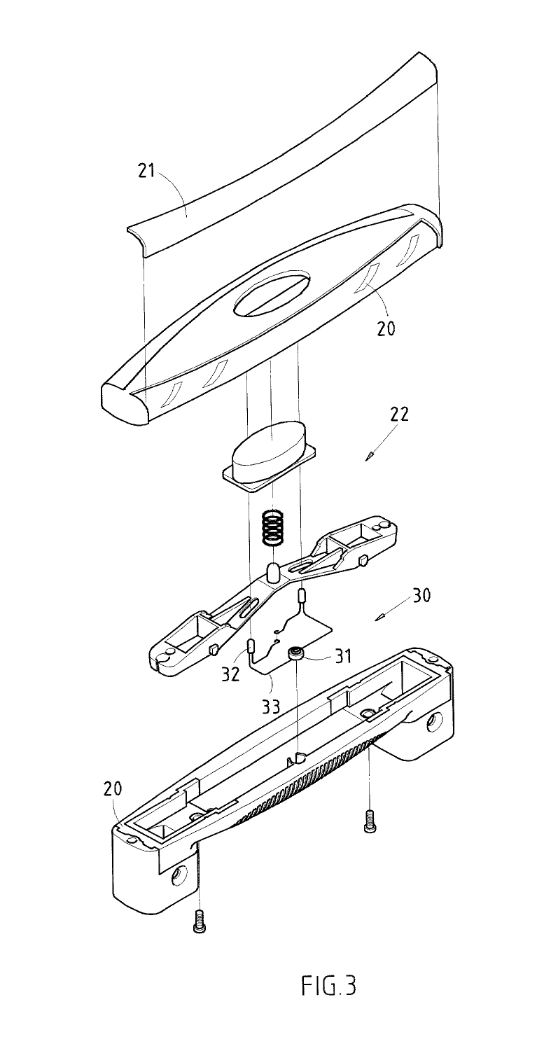

The main body 20 is provided with one or more decorative pieces 21 to give the handle of the present invention and added esthetic effect. The decorative pieces 21 are various in color and form, as illustrated in FIGS. 3, 4, and 5. The esthetic effect of the handle of the present invention is greatly enhanced by the refraction of light emitted by the light-emitting bodies 32.

The present invention described above is to be regarded in all respects as being merely illustrative and not restrictive. Accordingly, the present invention may be embodied in other specific forms without deviating from the spirit thereof. The present invention is therefore to be limited only by the scopes of the following appended claims.

I claim:

1. A handle comprising:
a main body made of a transparent or translucent material and provided in an interior with a receiving space;
a control member formed of a press button and a spring, said control member being disposed in said receiving space of said main body such that said press button is partially jutted out of an upper surface of said main body; and
a light-emitting member formed of a battery, one or more light-emitting bodies, and a circuit in communication with said battery and said light-emitting bodies, said light-emitting member being disposed in said receiving space of said main body such that said light-emitting member is located under said control member, and that said battery is connected with said light-emitting bodies at such time when said control member is forced by an external force to make contact with said light-emitting member, thereby resulting in emission of light by said light-emitting bodies whereby said light-emitting bodies become disconnected with said battery at such time when said control member is relieved of the external force, thereby resulting in cessation of emission of light by said light-emitting bodies.

2. The handle as defined in claim 1, wherein said main body is provided with one or more decorative pieces of various colors and forms.
